(19) United States
(12) Patent Application Publication
(10) Pub. No.: US 2026/0081791 A1
(43) Pub. Date: Mar. 19, 2026

(54) COMPUTING SYSTEMS AND METHODS FOR REMEDIATING PERMISSIONS ISSUES IN DURABLY CREDENTIALED SYSTEMS

(71) Applicant: Dell Products L.P., Round Rock, TX (US)

(72) Inventors: Bradley K. Goodman, Nashua, NH (US); Joseph B. Caisse, Burlington, MA (US)

(73) Assignee: Dell Products L.P., Round Rock, TX (US)

(21) Appl. No.: 18/884,557

(22) Filed: Sep. 13, 2024

(51) Int. Cl. H04L 9/32

(52) U.S. Cl. CPC H04L 9/3265; H04L 9/3247

(57) ABSTRACT

Systems and methods and computer program products support remediating a cryptographic chain of authorization. For instance, an item of work may be performed under the authority of a node, which itself was delegated authority by another node or a root of authority. In an instance in which the item of work is long-standing, and in which a link in the cryptographic chain of authorization may have expired or been revoked, a technique may include using previously-stored certificates to generate a substitute cryptographic chain of authorization to allow the work.

### FIELD

The present disclosure relates to computing systems and, more particularly, to systems and methods for remediating permissions issues in durably credentialed systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In various embodiments, a method includes: performing a verification operation for a request for work, wherein the request for work includes a statement of work and a cryptographic chain of authorization, wherein the cryptographic chain of authorization includes a first authorization, which references a second authorization; analyzing cached data of the chain of authorization, including the first authorization and the second authorization; determining, based on the analyzing, that the first authorization has expired or been revoked; transmitting a first message to a control plane node, the first message indicating a failure of the cryptographic chain of authorization; receiving a second message from the control plane node, the second message including a substitute cryptographic chain of authorization; verifying that the substitute cryptographic chain of authorization authorizes the request for work; and performing work identified in the request for work.

In various embodiments, an IHS (Information Handling System) includes: one or more processors; one or more memory devices coupled to the one or more processors, the one or more memory devices storing computer-readable instructions that, upon execution by the one or more processors, cause the IHS to: receive an indication of a request for work having a failed cryptographic chain of authorization, wherein the indication is received from an endpoint running a workload according to the request for work; analyze cached cryptographic authorizations, including identifying a substitute cryptographic chain of authorization, sufficient to authorize the work, and connecting a node associated with the request for work to a root of authority; and transmit a message, including the substitute cryptographic chain of authorization, to the endpoint.

In various embodiments, a computer-readable storage device having instructions stored thereon for decommissioning a cloud resource, wherein execution of the instructions by one or more processors of an information handling system (IHS) causes the one or more processors to: perform a verification operation for a request for work, wherein the request for work includes a statement of work and a cryptographic chain of authorization, wherein the cryptographic chain of authorization includes a first authorization, which references a second authorization; analyze cached data of the chain of authorization, including the first authorization and the second authorization; determine, based on the analyzing, that the first authorization has expired or been revoked; transmit a first message to a control plane node, the first message indicating a failure of the cryptographic chain of authorization; receive a second message from the control plane node, the second message including a substitute cryptographic chain of authorization; and perform work identified in the request for work based on verifying the substitute cryptographic chain of authorization.

### BRIEF DESCRIPTION OF THE DRAWINGS

The present disclosure may be better understood, and its numerous objects, features and advantages made apparent to those skilled in the art by referencing the accompanying drawings. The use of the same reference number throughout the several figures designates a like or similar element.

FIG. 1 illustrates an example multiple node environment according to at least one embodiment of the present disclosure.

FIG. 2 is an illustration of example cryptographic chains of authorization, according to some embodiments.

FIG. 3 is an illustration of an example process to generate a request, according to some embodiments.

FIG. 4 is an illustration of an example process to generate a request, according to some embodiments.

FIG. 5 is an illustration of an example method, according to some embodiments.

FIG. 6 is an illustration of an example method, according to some embodiments.

FIG. 7 shows an example processing platform including cloud infrastructure, according to some embodiments.

FIG. 8 shows an example processing platform, according to some embodiments.

### DETAILED DESCRIPTION

In the following description, numerous specific details are set forth in order to provide a thorough understanding of embodiments of the present disclosure. It will be apparent to one skilled in the art that embodiments of the present disclosure may be practiced without some of these specific details. Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). While embodiments of the present disclosure have been illustrated and described, the disclosure is not limited to these embodiments only. Numerous modifications, changes, variations, substitutions, and equivalents will be apparent to those skilled in the art, without departing from the scope of the disclosure, as described in the claims.

Various implementations provide systems, methods, and computer program products to remediate permissions issues when a permission may have been revoked or may have expired.

In some systems, a user may present a set of credentials to prove authorization to perform an action on a computer system. Chained cryptographic authorization is designed to allow such credentials to be long-standing (or durable). This means that such a credential, rather than being a simple way to perform an immediate, one-off-imperative task (e.g. “let me in the door”)—allows a user to make a longer-standing statement, (or more specifically, a statement of-work), while proving their authority to make such a statement (e.g. “device X should run application Y”). An item of work or a request for an item of work that depends upon a long-standing or durable authorization may also be referred to as long-standing or durable.

Retention by the recipient device of both the statement-of-work, and the credentials which prove this is authorized—form a collective declaration—which allows the security and permissions around this statement to be verified not only when a statement is received (by a device)—but in perpetuity. Meaning that if the recipient device was subsequently restarted, the recipient device may re-check the declaration in its own cache to verify that not only the application should continue to run (e.g., it should restart)—or an outside auditor who found the application running on the recipient device could be given proof that this application was indeed authorized to run on the recipient device.

Long-standing or durable credentials may present problems when aspects of how the credentials may be impacted by the lifecycle of such credentials. For example, credentials, like many cryptographic certificates, may contain expiration dates. Furthermore, certificates may also be subject to revocation or cancellation.

In a system which uses long-standing, durable declarations, credentials and certificates being expired or revoked may introduce problems. In one example, a statement-of-work states a particular endpoint device should run an application. A user may attach a permission indicating the user is authorized to request the application to run on the endpoint device; thus this declaration is sent to the endpoint device, which verifies the permissions and starts the application.

However, several months later, the user's permissions expire. If this declaration was written, and its validity came from a certificate which was no longer valid—one may argue that the declaration is no longer valid—meaning the application is not provably authorized to run.

In some systems, proof of authority is required to go back to the root of authority, or “owner” of a system. Example of an owner may include a cryptographic root of trust. An owner may delegate permissions to a subordinate, who may in-turn delegate some or all of that authority (or portions thereof) to yet another entity and so on. Ultimately, a user who is actually trying to do (or define) actual work may be required to prove authorization all the way back to the root or owner.

In an example chained cryptographic authorization request, when the request is generated, the initiator device may run an algorithm which looks at all available permissions in the system, attempting to find a suitable path from the root of the system down to the user authoring the request. If such a path exists, it may prove a user's suitability to specify the stated declaration. If the initiator device finds a suitable path, it may include permissions certificates in the path with the request to present a complete and authorized declaration to the recipient endpoint device.

Continuing with the example, the recipient endpoint device may cache permissions locally. This means if a requesting user were to send another request to the recipient endpoint device without any permissions, the recipient endpoint device may use one or more certificates in its local cache to find a suitable path from root of authority to the requesting user. If the recipient endpoint device were to find suitable permissions, then it may assume that the requested work is authorized. If the recipient endpoint device were unable to prove authorization, it may in some examples, transmit a request to the initiating device for additional proofs.

As noted above, it may be desirable to find a way to remediate discrepancies in cases where a permission in a previously-received declaration had expired or been revoked. Such expiration or revocation may have invalidated what had been a valid declaration on what might be an existing, running workload.

In one example, Alice is a user associated with the root of trust, and Alice has authorized Bob to perform an action. Bob has delegated his authority to Charlie to perform the action. Charlie (e.g., an initiating device) may send a request to perform the action to a recipient endpoint device. The request may include the chain of cryptographic authorization from Owner to Alice to Bob to Charlie. The recipient endpoint device may then cache that request in its local cache. In the future, Bob's permissions may have expired or been revoked, such that Bob would no longer be authorized to do the work and no longer authorized to delegate to Charlie. The recipient endpoint device may then recognize that the chain of authorization is no longer valid and may then send a message to the initiator or control plane node to remediate the chain of authorization.

A control plane node may include a more comprehensive cache of certificates and/or permissions. Various embodiments may include software or firmware functionality for the initiating device or the control plane node to search the comprehensive cache to determine if there is another path from Alice to Charlie. For instance, the comprehensive cache may include permissions that indicate that Alice had authorized Dawn, who had also authorized Charlie, to perform the same action. The software or firmware functionality may be configured to identify that chain of permissions from Alice to Dawn to Charlie so that the requested work is allowed. The initiating device or control plane node may then remediate the request to include the valid chain of authorization and send the remediated request to the recipient endpoint device.

Continuing with the example, the recipient endpoint device may determine, based on the identified chain from Alice to Dawn to Charlie, that the request is allowed, and the recipient endpoint device may then perform the requested work. The recipient endpoint device may also save the corrected (remediated) declaration in its local cache.

Had the initiator or control plane node not found a suitable path from Alice to Charlie, then the initiator control plane node may instead have performed an error routine, such as denying access, alerting an administrator, or the like.

Various embodiments may include advantages over other solutions. For instance, the embodiment described above, in which the initiator or control plane node is configured to search for a substitute chain of permissions and, if in response to finding a substitute chain of permissions, remediates the request, the work may get performed without further manual burden on a system administrator. Furthermore, such embodiments may allow the other parts of the declaration to remain as-is, such as by keeping the Owner to Alice link in the chain and the statement of work.

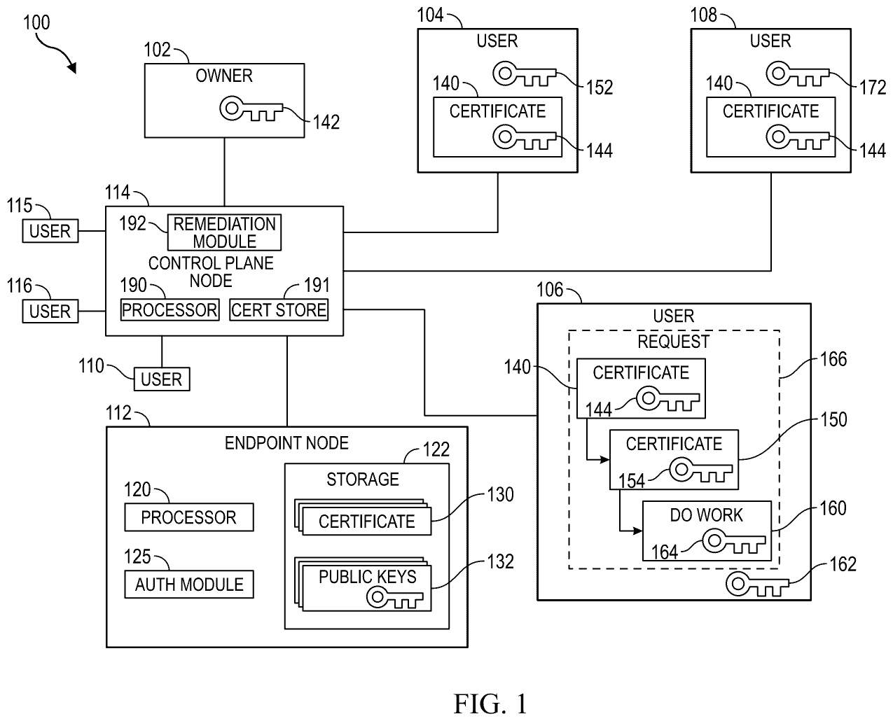

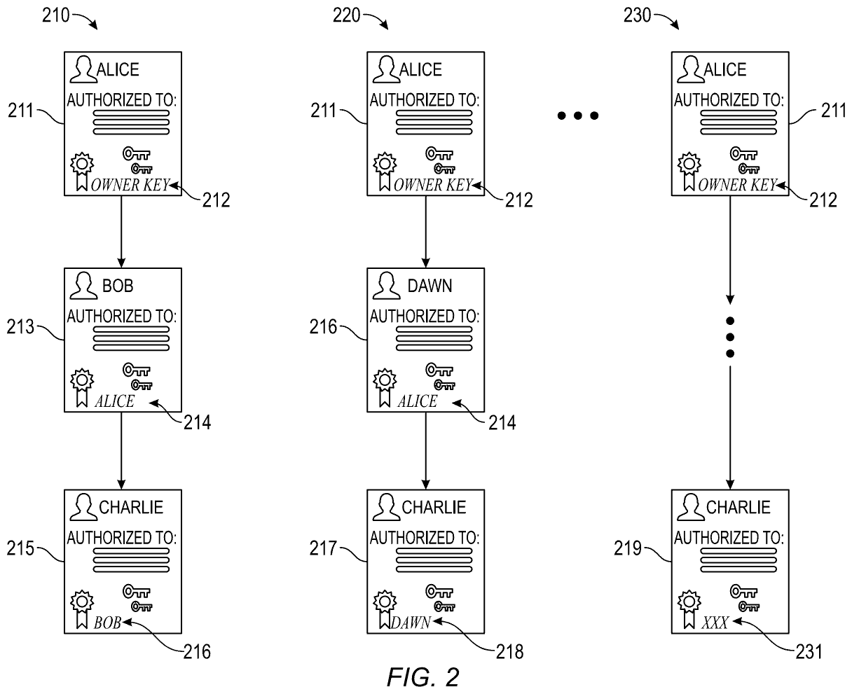

FIG. 1 illustrates a multiple node environment 100 according to at least one embodiment of the present disclosure. As explained in more detail below, endpoint node 112 includes an authorization module 125, which may include computer-readable instructions that may be executed by processor 120 to authenticate a user making a request. Control plane node 114 includes a processor 190, a certificate store 191, and a remediation module 192. Control plane node 114 may be configured to work with an initiator device (e.g., user 115 or 116) to run computer-executable code on processor 192 perform the functions of remediator module 192. For instance, remediator module 192 may be configured to identify one or more alternative chains of authority from certificate store 191 and to remediate a request with an updated chain of authorization before sending that updated request to endpoint node 112. Thus, in some examples, remediation module 192 may remediate permissions that have been revoked or have expired, such as described with respect to FIGS. 2-6.

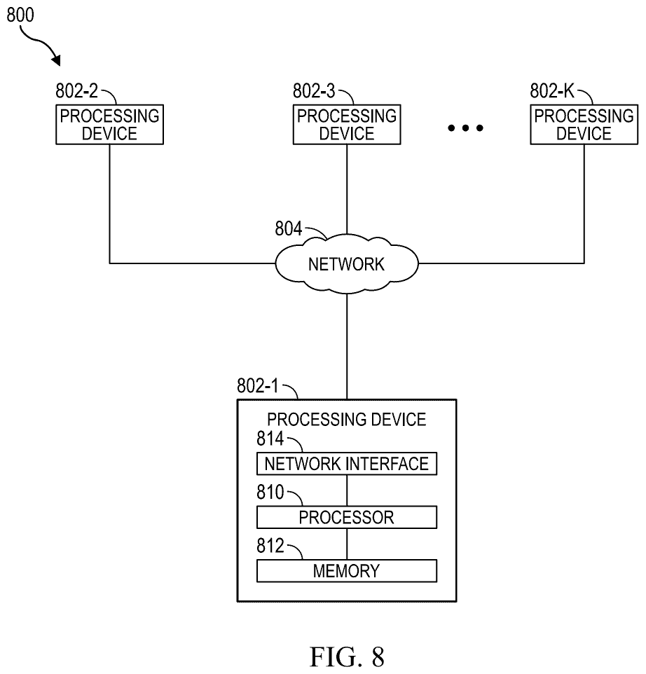

Multiple node environment 100 includes an owner node 102, user nodes 104, 106, 108, 110, 115, and 116 an endpoint node 112, and a control plane 114. In an example, owner node 102 and user nodes 104, 106, 108, 110, 115, and 116 may access endpoint node 112 through control plane 114. In certain examples, each user node 104, 106, 108, 110, 115 and 116 may include a processor and a memory. Endpoint node 112 may include a processor 120 and a storage 122. Control plane (CP) node 114 may include any suitable type of control-plane, such as a global control plane node, regional control plane node, and local control plane node. In an example, global CP nodes, regional CP nodes, local CP nodes, and user nodes 104, 106, 108, 110, 115 and 116 and endpoint node 112 may be any suitable information handling system (IHS), such as substantially similar to device 802-1 of FIG. 8, wherein each node may include a storage and a processor as described below with respect to FIG. 8. Multiple node environment 100 may include any suitable number of additional components or information handling systems without varying from the scope of this disclosure.

In an example, endpoint node 112 may store one or more certificates 130 and one or more public keys 132 in storage 122. Public keys 132 may be utilized by endpoint node 112 to authenticate any received messages or requests. In certain examples, an owner public key 132 may be hard coded within endpoint node 112 or any other suitable node outside of the control plane of multiple node environment 100. Owner public key 132 may be associated with owner node 102 of endpoint node 112, such as a company, a user, or the like. In an example, security of owner public key 132 may be increased based on the owner public key being stored within a trusted platform module (TPM) of endpoint node 112. Each public key 132 may be associated with different user node, such as user nodes 104 and 106.

In certain examples, owner 102 may perform one or more suitable operations to grant one or more rights or operations to user 104. For example, owner 102 may provide a signed certificate 140 to user 104 via control plane node 114. In an example, certificate 140 may authorize user 104 to request that one or more services or operations be performed in endpoint 110. For example, certificate 140 may authorize user 104 to do anything in endpoint node 112. Certificate 140 may include a key signature 144 that was generated from owner private key 142.

In certain examples, user node 104 may perform one or more suitable operations to grant or delegate one or more rights or operations to user node 106. For example, user node 104 may provide a signed certificate 150 to user node 106 via control plane node 114. In an example, certificate 150 may authorize user 106 to request that one or more services or operations be performed in endpoint 110. For example, certificate 150 may authorize user 106 to do anything in endpoint node 112. Certificate 150 may include a key signature 154 that was generated from user private key 152.

In certain examples, user node 106 may generate a work order 160 that includes a key signature 164 created from user private key 162. As illustrated in FIG. 1, certificate 150 may include a signature derived from certificate 140, which in turn may authenticate user 104 to request any operation identified in certificate 140. Similarly, work order 160 may include a signature derived from certificate 150, which in turn may authenticate user 106 to request any operation identified in certificate 150. In an example, user 106 may generate and provide a request 166 including, but not limited to, an imperative request and a declarative request. Request 166 may include certificates 140 and 150, and work order 160, which in turn may enable endpoint node 112 to authorize or validate the work request 166.

In an example, an imperative request or command may involve a particular action to be performed. For example, an imperative request may be for a memory in an endpoint, such as endpoint 112, to be locked. In response to the imperative request, the endpoint may lock the designated memory. Subsequently, another request may be received to unlock the memory at which point the memory may be unlocked and the imperative request may no longer have any effect.

In an example, a declarative request or command may involve an action to be performed for an extended amount of time. For example, a declarative request may indicate that a memory should be locked. In response to the declarative request, the endpoint may lock the designated memory. Subsequently, another request may be received to unlock the memory at which point the memory may be unlocked. In an example, the declarative request may be different than an imperative request based on the declarative request still being implemented after the subsequent request was performed. For example, if the declarative request is for the memory to be locked and a subsequent request unlocks the memory, the declarative request may cause the memory to be locked again after the subsequent request is no longer being performed. In certain examples, a component, such as a memory, in an endpoint node may have a default state, a declarative request may cause the endpoint to place the component in a declarative state, and an invalidate request may end the declarative request or state so that the component is placed back in the default state.

In an example, cryptographic chains, such as the chain from certificate 140, to certificate 150, and to work order 160, may be used to attest the credentials and authorization of user node 106 to make a request, such as in a certificate-chain-based permissions model. In this situation, a request may be small, but the certificate chain required conveying permissions to do such an operation may be significantly longer.

In some security models, trust may be conveyed from one party or node to another by means of a chain of certificates. In an example, the chain of certificates may be a manner by which each entity in the chain is attested by another, until finally reaching a pre-established trusted entity, such as a ‘root’ node or owner. In certain examples, the chain of certificates may be created by enrolling one or more root certificate authorities onto multiple node environment 100. When one entity, such as a web server, presents its credentials via a certificate to an endpoint node, the entity may present the parent credentials of the node that authorized the entity via an intermediate certificate along with it. In an example, the length of certificates may vary, based the metadata, the size of the keys used, and the number of entities in the certificate chain. Furthermore, these certificate chains may be re-presented upon every connection.

In an example, owner node 102 may be the root authority for endpoint node 112. User node 106 may send request 166 to endpoint node 112. For this request to be fully attested, user node 106 may include two more assertions or certificates, certificate 140 stating owner node 102 gives permission to user node 104 to do anything, and certificate 150 which states that user node 104 permits user node 106 to perform a particular operation in endpoint node 112. Therefore, endpoint node 112 may be able to prove that user node 106 was authorized by user node 104 who was authorized by owner node 102 who is the root of authority; therefore, this request is attested. In certain examples, user node 106 may be a server, user node 104 may be an intermediate certificate authority server, and owner node 102 may be a root certificate authority server.

In an example, after endpoint node 112 has received certificates 140 and 150, processor 120 may execute authorization module 125 to verify or authenticate work order 160 in request 166 using the certificates. Based on work order 160 and request 166 being verified, processor 120 may perform or execute the operation in the request. In an example, endpoint node 112 may store certificates 140 and 150 in the group of certificates 130 within storage 122. Based on certificates 140 and 150 being stored in storage 122, endpoint node 112 may be able to utilize the stored certificates to authenticate a repeat of request 166 from user node 106 via authentication module 125. As used herein, a repeat of request 166 may be a subsequent request associated with only the same operations as request 166.

Also, the endpoint node 112 may store the work order 160 in its storage 122. The endpoint node 112 may from time to time check the work order 160 as well as its accompanying certificates to determine that the work is still authorized. This may be beneficial in the case of a long-standing work item, which may survive one or more restarts of the endpoint device 112.

Furthermore, as various requests and requests for work come in, endpoint node 112 may store the associated certificates in certificate store 130. As a result, endpoint node 112 may include a multitude of certificates in certificate store 130, where those certificates may evidence various chains of cryptographic authorization.

In yet another example, should endpoint node 112 be restarted, it may attempt to attain its state prior to being restarted, such as by performing various items of work that have long-standing duration, such as running a hypervisor or application. Such tasks with long-standing duration may be the result of prior requests, where the requests and their associated statements of work and certificates may be stored in storage 122 by endpoint node 112. The endpoint node 112 may search those statements of work for long-standing work requests, ensure that the associated certificates in group of certificates 130 provide proper authorization, and then begin performing those tasks. The endpoint node 112 may in some examples attempt to attain its state even without receiving further requests from another user.

In one example, a request for work having a long-standing duration passes a point in time in which one or more certificates in its chain of authorization are either expired or revoked. The endpoint node 112 may search through its certificates 130 to determine a chain of authorization for an item of work. For instance, upon restart, the endpoint node 112 may search through its items of work and chains of authority to attempt to attain its state prior to being restarted. Additionally or alternatively, the endpoint node 112 may search through its items of work and certificates 130 based on a set time period, upon prompting by an administrator, upon prompting by another node, or at any other appropriate time. The endpoint node 112 may determine that some of its items of work correspond to an invalid chain of authorization and may, in response, send a message to an initiator node and/or the control plane node 114 to indicate the invalid chain of authorization. In response, the initiator node and/or control plane node 114 may use remediation module 192 and certificate store 191 to remediate a work request, if possible. The initiator node and/or control plane node 114 may then transmit a remediated work request to the endpoint node 112 if available.

Of course, the scope of implementations is not limited to any specific quantity of nodes in multi-node environment 100, as a given embodiment may include any appropriate quantity of nodes. Furthermore, the scope of implementations is not limited to any quantity of links in a chain within a request. For instance, the request 166 includes two links—owner 102 to user 104, as evidenced by certificate 140, and user 104 to user 106, as evidenced by certificate 150. However, other implementations may have two links, three links, or more, as may be appropriate for a particular use case. In the example of FIG. 1, users 115 and 116 may be implemented similarly to user 104 and may also have one or more delegations from owner 102 and one or more delegations from other users as well. In one example, a chain of cryptographic authorization may go from owner 102 to user 104 to user 115 to user 116 to user 106. In another example, a chain of cryptographic authorization may go from owner 102 to user 115 to user 116 to user 106, skipping user 104. In such examples, user 106 would then verify a request (not shown) that uses a given chain by verifying through each of those links back to owner 102.

FIG. 2 is an illustration of example cryptographic chains of authorization 210, 220, 230, according to some embodiments. The example of FIG. 2 uses names, rather than numbers, to identify different users for sake of convenience. Any of the users Alice, Bob, Charlie, or Dawn may correspond to a respective one of the users 104, 106, 108, 115, or 116 of FIG. 1. The examples of FIG. 2 illustrate different ways for a chain of authorization to delegate authority from an owner (not shown) to Alice and to Charlie through various intermediate users.

Cryptographic chain of authorization 210 includes certificates 211, 213, and 215. Certificate 211 is the first link in chain 210, and certificate 211 includes owner signature 212, and it authorizes Alice to perform one or more work items. An example of an owner in FIG. 1 is owner 102. Certificate 213 includes Alice's signature 214, and it authorizes Bob to perform one or more work items, where certificate 213 is a delegation of Alice's authority. Certificate 213 may authorize Bob to perform some or all of the work items for which Alice is authorized by certificate 211. Certificate 215 includes Bob's signature 216, and it authorizes Charlie to perform some or all of the work items that Bob is authorized to perform by certificate 213. Certificate 215 is a delegation of Bob's authority. Charlie may generate a work order for an authorized work item and may include the work order in a request along with the certificates 211, 213, 215. The links from Alice to Bob to Charlie, assuming they are all valid, allow Charlie to perform the authorized work item.

Cryptographic chain of authorization 220 illustrates an example of remediation, via substitution of certificate 216 in lieu of certificate 213 and certificate 217 in lieu of certificate 215. Specifically, certificate 216 includes Alice's signature 214, and it authorizes Dawn to perform one or more work items. In other words, certificate 216 is a delegation of some or all of Alice's authority to Dawn. The authorization of certificate 216 to Dawn may or may not be coextensive with the authorization of certificate 213 to Bob, but the authorization of certificate 216 to Dawn authorizes at least the actions found in certificate 215. Furthermore, certificate 217 is a delegation of some or all of Dawn's authority, which Dawn received from Alice. Certificate 217 includes Dawn's signature 218. Furthermore, in this example, certificate 217 authorizes at least the actions found in certificate 215. Therefore, cryptographic chain of authorization 220 is substantially similar to cryptographic chain of authorization 210, though using Dawn instead of Bob as an intermediate link.

Cryptographic chain of authorization 230 includes certificate 211 and certificate 219, and any appropriate certificate or certificates may be included in the intervening links between Alice and Charlie. For instance, chain 230 may include three certificates, such as shown in chain 220, or may include four or more certificates total, as long as it results in Charlie being authorized to perform a work item. For instance, whichever work items are authorized in certificate 215 should be authorized in each prior link in a given chain, thereby providing proper authority from the root of authority to certificate 219. Certificate 219 includes a signature 231, which may be a cryptographic signature of an immediately-previous link (not shown) in the chain 230, and that immediately-previous link and any other links in the chain 230 properly go back to the owner through certificate 211.

Ellipses between chain 220 and chain 230 indicates that there may be other possibilities for different cryptographic chains of authorization for a given system.

In various embodiments, remediation module 192 is configured to search the certificate store 191 for appropriate certificates, including for particular work items authorized through delegation, to generate substitute cryptographic chains of authorization, such as chains 220 and 230. Remediation module 192 may also be configured to modify a request by substituting one or more certificates for other certificates. Furthermore, remediation module 192 may also be configured to generate and transmit a request, based upon any appropriate chain of authorization, such as any of chains 210, 220, or 230.

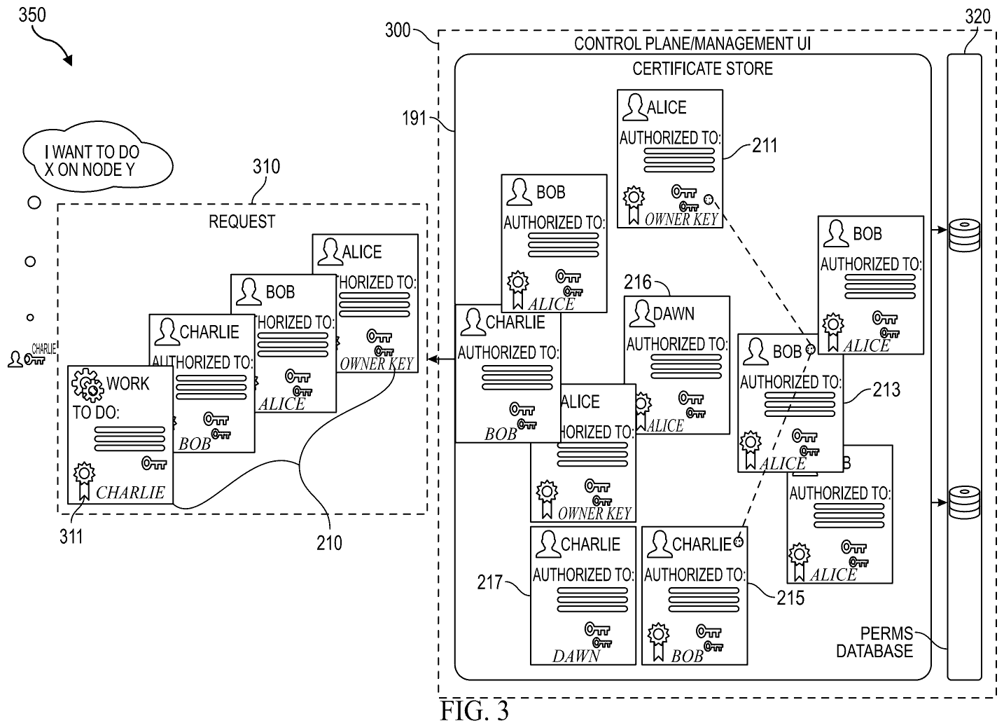

FIG. 3 is an illustration of example process 350 to generate a request, according to some embodiments. In the present example, an initiating node may communicate with control plane management interface 300 to generate a request, such as request 310. The control plane management interface 300 may include software functionality, executable by processor 190, of control plane node 114. In other words, in this example, an initiating node (e.g., any of nodes 104, 106, 108, 110, 115, 116) may not directly generate a request, but rather, may instead communicate with control plane node 114 to generate the request. This is because an initiating node may not, by itself, have access to a comprehensive store of certificates, such as example certificate store 191. Further in this example, the initiating node may use the control plane management interface 300 to search for permissions, perhaps even through intermediate nodes, to generate a request.

In the example depicted in FIG. 3, Charlie may desire to send request 310 to endpoint node 112 to cause endpoint node 112 to perform a work item. Charlie may then communicate with control plane management interface 300 to gather certificates for a cryptographic chain of authorization to accompany statement of work 311 in the request 310. In one example, the control plane management interface 300 may step backwards from Charlie's permissions, such as with certificate 215, to find authorization from either an intermediate node or directly from the owner. Such process may be recursive, one link in the chain at a time, until control plane management interface 300 completes the chain from Charlie to the owner.

The control plane management interface 300, working with the initiator node Charlie, may then identify cryptographic chain of authorization 210 through the recursive process and place the corresponding certificates 211, 213, 215 in the request 310 with the statement of work 311. The control plane node 114 may then transmit the request 310 as a message to the endpoint node 112 over a network (not shown).

Further in this example, the item of work specified in the statement of work 311 may be a long-standing work item, such as may be expected to continue until explicitly instructed otherwise. For instance, a long-standing duration work item may request that the endpoint node 112 perform the requested work item and maintain that state until another request (properly authorized) is received by the node 112 causing the node 112 to end the work item. An example may include running a hypervisor or application on the endpoint node 112, though the scope of implementations may include any appropriate long-standing duration work item.

Continuing with the example, the intermediate link in chain 210 includes the delegation of authority from Alice to Bob, as evidenced by the certificate 213. In a scenario in which Bob's authority either expires or is revoked, the endpoint node 112 may be configured to consider any work item depending upon Bob's authority to be on authorized due to the invalid cryptographic chain of authorization. For instance, the endpoint node 112 may be restarted, which may cause it to check chains of authority in its own local cache 130, or there may be another event which causes endpoint node 112 to check chains of authority in its own local cache 130. In any event, endpoint node 112, via authorization module 125, may determine that request 310 is no longer valid and may generate a message (not shown) to Charlie via control plane node 114. The message from endpoint node 112 to Charlie may indicate the particular request (e.g., identifying particularly request 310 or any of its constituent parts) and either ask for a new request or simply flag the error.

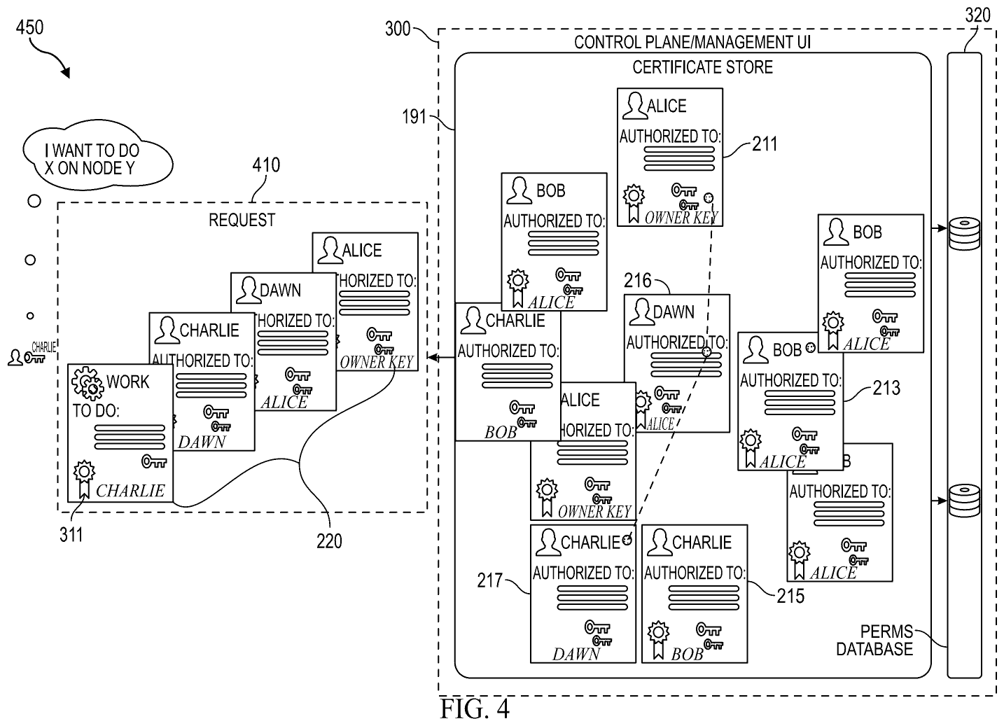

FIG. 4 is an illustration of an example process 450 to generate a request, according to some embodiments. Example process 450 picks up where example process 350 left off. That is, the control plane node 114 and the Charlie node have received a message from endpoint node 112 indicating that the cryptographic chain of authorization for the statement of work 311 has expired.

In response to the message from endpoint node 112, Charlie coordinates with the control plane management interface 300 to generate replacement request 410 with a substitute cryptographic chain of authorization. For instance, the control plane management interface 300 may work with the functionality of remediation module 192 to identify the substitute cryptographic chain of authorization. For instance, the remediation module may search for a certificate granting Charlie authority to request the particular work item specified in statement of work 311. Remediation module 192 may parse the contents of the certificates in certificate store 191 and identify certificate 217. Further, the remediation module 192 may recursively search contents of the other certificates to determine whether the authority delegated in certificate 217 may be properly traced to the owner. Accordingly, the remediation module 192 may identify certificate 216 and certificate 211, which forms cryptographic chain of authorization 220.

Remediation module 192, in concert with control plane management interface 300, may then substitute certificates 216 and 217 for certificates 213 and 215 in request 410. The control plane node 114 may then transmit the request 410 to the endpoint node 112 in a message over a network (not shown). The endpoint node 112 may then verify the authorization using authorization module 125 and, in response, may then perform the requested item of work. The endpoint node 112 may further store the request 410, including the certificates 216 and 217, to its certificates 130.

As noted above in this example, the work described in the statement of work 311 has a long-standing duration. Accordingly, the endpoint node 112 may perform that item of work and maintain that state until instructed otherwise. Therefore, endpoint node 112 may check the cryptographic chain of authorization 220 from time to time (e.g., at restart) by checking the stored request 410 and its accompanying certificates and statement of work 311. Assuming that none of the certificates 211, 216, 217 have expired or been revoked, the endpoint node 112 and its authorization module 125 may determine that the cryptographic chain of authorization is still valid and may determine to continue performing the item of work. However, if one or more of the certificates 211, 216, 217 have expired or been revoked, the endpoint node 112 may transmit a message (such as explained above) to the control plane node 114 and Charlie. In response, the control plane node 114 may, if possible, generate a further work request with a subsequent substitute cryptographic chain of authorization. If not possible, then the control plane node 114 may perform an error function, such as alerting an administrator, returning an error to endpoint node 112, or the like.

Some embodiments may include permissions database 320, which may be associated with control plane node 114 and may be accessible by control plane management interface 300 and remediation module 192. In such embodiments, the permissions database 320 may include a relational database or other appropriate type of database, which includes a multitude of entries that may be searched by delegating node ID, delegated node ID, certificate ID, work items authorized by certificate, expiration date, revocation status, and/or the like. The data for the entries may be less than a total amount of data for the certificate store 191, such as by omitting cryptographic keys themselves or other data. In such embodiments, the permissions database 320 may provide a more efficient way to search than simply searching through certificates in certificate store 191. For instance, permissions database 320 may allow the control plane management interface 300 and/or remediation module 192 to search for substitute cryptographic chains of authorization by using database search queries (e.g., SQL queries). In other words, some embodiments may allow for storing a digest of the certificate store 191 in permissions database 320 and using the permissions database 320 as a primary search reference, rather than relying on the certificate store 191 itself is a primary search reference. An advantage of such embodiments may be increased efficiency due to faster searches that may use less computational power.

Some embodiments may include advantages over other solutions. For instance, the process described above with respect to FIGS. 3 and 4 is performed using previously-stored certificates in the certificate store 191. The remediation module 190 was able to generate work request 410 from the previously-stored certificates, rather than resorting to acquiring new certificates. In other words, such process may increase efficiency of a computer system by acquiring the substitute cryptographic chain of authorization more quickly than would have otherwise been performed by a technique that requires a newly-signed certificate. Nevertheless, the scope of implementations does not exclude that some instances may include newly-signed certificates when previously-saved certificates may not be available.

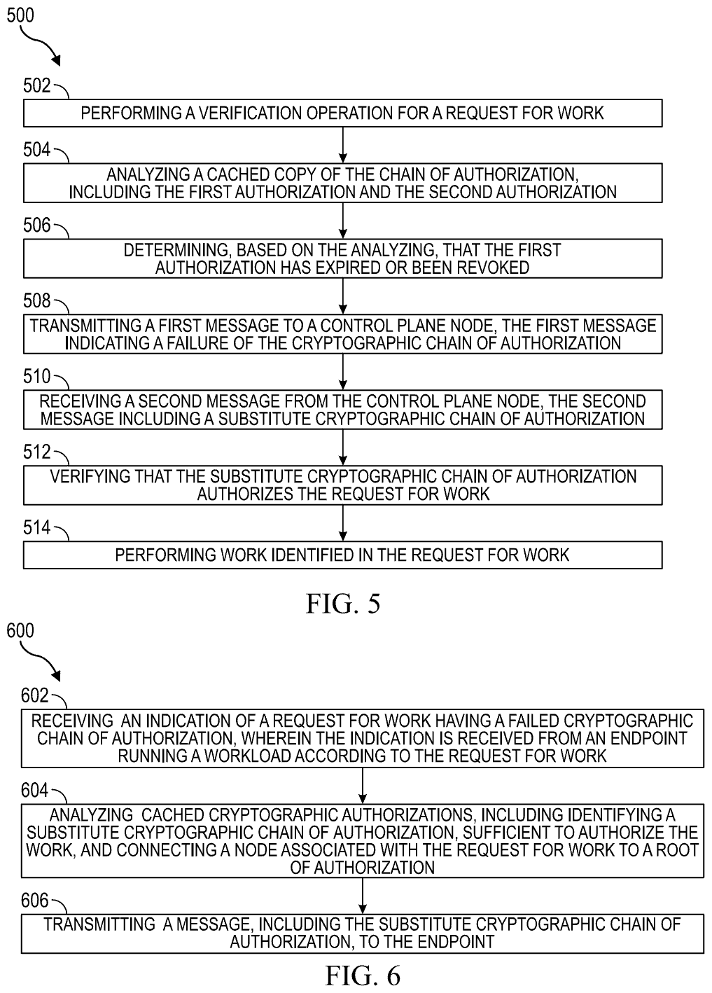

FIG. 5 is an illustration of example method 500, according to some embodiments. Method 500 may be performed by an IHS, such as an endpoint node (e.g., endpoint node 112). For instance, the IHS may include one or more processors and computer readable media, where computer-readable code stored to the computer-readable media when executed by the one or more processors may cause the IHS to perform the functions described with respect to method 500.

At action 502, the IHS performs a verification operation for a request for work. For instance, the IHS may be an endpoint node, which has an existing or running workload when the IHS is reset or powered up. The IHS attempts to attain its prior state, including executing long-standing work items that are stored in its cache. The IHS may parse its cache, examining the work requests, and verifying the work requests.

In one example, the IHS may have cached a request with a statement of work indicating a long-standing work item, such as running an application on the endpoint device, running a hypervisor on the endpoint device, and/or the like. In other words, the long-standing work item may include a work item that is an existing, running workload at the time that the IHS is powered down or reset.

The IHS may include an authorization module, which is configured to verify a request for work, including verifying a cryptographic chain of authorization included in the request for work. Verifying the cryptographic chain of authorization may include verifying that the links lead from the requesting device to the root of authority, with authentic cryptographic certificates that have not expired or been revoked.

Action 504 includes analyzing a cached copy of the chain of authorization. In other words, the verifying of action 502 may include analyzing a cached copy of the cryptographic chain of authorization, where the endpoint node itself has performed the caching. The cryptographic chain of authorization may include a multitude of signed certificates, where each certificate is a link in a chain of authorizations, each certificate indicating a delegation of authority from one node to another node. Looking at the example of FIG. 2, it includes a cryptographic chain of authorization 210, where a first authorization is represented by certificate 215, which is a delegation of authority from Bob to Charlie, and its signature by Bob acts as a reference back to the certificate 213. The certificate 213 is an example of a second authorization, as it proves delegation of authority from Alice to Bob, and it is signed by Alice. A given cryptographic chain of authorization may include any appropriate quantity of links.

Action 506 includes determining, based on the analyzing, that the first authorization has expired or been revoked. For instance, Bob's credentials may have expired or been revoked, which further means that the delegation of authority to Charlie by certificate 215 has expired or been revoked. In one example, action 506 may include the IHS, via authorization module 125, parsing the certificates in the cache and comparing expiration dates or revocation timestamps to a present time. Of course, the analysis of action 506 may be performed in any appropriate manner.

Action 508 includes transmitting a first message to a control plane node to indicate a failure of the cryptographic chain of authorization. For instance, the IHS acting as the endpoint node may transmit a message to an IHS acting as a control plane node. The message may include any appropriate content, such as a request for remediation of the cryptographic chain of authorization, an indication of which credentials have expired, a request for an updated work request, and/or the like.

Action 510 includes receiving a second message from the control plane node. In this example, the second message includes a substitute cryptographic chain of authorization. For instance, the second message may include an updated work request. The updated work request may include the same statement of work and the substitute cryptographic chain of authorization. An example substitute cryptographic chain of authorization is described above with respect to FIG. 4 and cryptographic chain of authorization 220.

Action 512 includes verifying that the substitute cryptographic chain of authorization authorizes the request for work. For instance, the statement of work may be signed by a requesting node (e.g., Charlie), and the substitute statement of work may show delegation of authority to Charlie, through one or more intermediate nodes, back to a root of authority. The links in a cryptographic chain of authorization are described in more detail with respect to FIG. 2. The IHS acting as the endpoint node may include a module, such as authorization module 125, which may perform the verification operation of action 512 in a same or similar manner as that described above with respect to action 502.

Action 514 includes performing work identified in the request for work. For instance, the request for work may include a long-standing item of work. Action 514 may include resuming the item of work in response to the verification of action 512.

FIG. 6 is an illustration of example method 600, according to some embodiments. Method 600 may be performed by an IHS, such as control plane node 114, which may work in concert with a requesting node, which may also be implemented as an IHS. For instance, an IHS performing method 600 may include one or more processors and computer readable media, where computer-readable code stored to the computer-readable media when executed by the one or more processors may cause the IHS to perform the functions described with respect to method 600.

Action 602 may include receiving an indication of a request for work having a failed cryptographic chain of authorization. For instance, an IHS acting as a control plane node may receive an indication, such as the first message described above with respect to action 508. The IHS may be configured so that it begins an attempt to remediate the failed cryptographic chain of authorization in response to receiving the message. Further in this example, the indication is received from an endpoint running a workload according to the request for work. In one example, the endpoint may be in a reset operation, which works to restore a workload, according to a state of the endpoint before the reset operation.

At action 604, the IHS analyzes cached cryptographic authorizations. The analyzing may include identifying a substitute cryptographic chain of authorization, which is sufficient to authorize the work. Action 604 may include analyzing certificates themselves and/or may include analyzing a digest of the certificates, such as in a database. Furthermore, the substitute cryptographic chain of authorization may connect a node associated with the request for work (e.g., a requesting node) to a root of authority. An example of a cryptographic chain of authorization includes cryptographic chain 210 and cryptographic chain 220 of FIG. 2. In the examples of FIGS. 3 and 4, the cryptographic chain 210 fails, and the control plane node identifies substitute cryptographic chain 220.

At action 606, the IHS transmits a message, including the substitute cryptographic chain of authorization, to the endpoint. For instance, the indication at action 602 may have been received from an endpoint device, and the message at action 606 may be transmitted back to that same endpoint device. The message may include, in addition to the substitute cryptographic chain of authorization, other components of a request for work. Examples of other components in a request for work may include a statement of work, which has been signed by the requesting device.

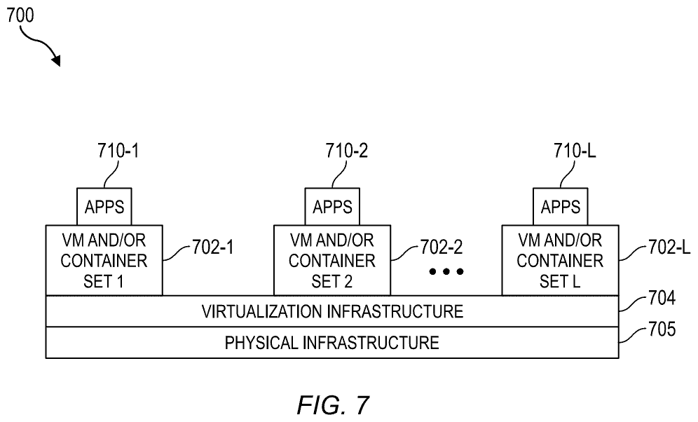

FIG. 7 shows an example processing platform including cloud infrastructure 700. Cloud infrastructure 700 may represent an architecture that may be adopted by any of the devices described herein. For instance, the devices of the users 104, 106, 108, 110, 115, 116, the devices of the owner 102, the endpoint node 112, and the control plane node 114, may be implemented using cloud infrastructure 700.

The cloud infrastructure 700 may include multiple virtual machines (VMs) and/or container sets 702-1, 702-2, . . . 702-L implemented using virtualization infrastructure 704. The virtualization infrastructure 704 runs on physical infrastructure 705 and may include one or more hypervisors and/or operating system-level virtualization infrastructure. The operating system-level virtualization infrastructure may include kernel control groups of a Linux operating system or other type of operating system.

The cloud infrastructure 700 further may include sets of applications 710-1, 710-2, . . . 710-L running on respective ones of the VMs/container sets 702-1, 702-2, . . . 702-L under the control of the virtualization infrastructure 704. Furthermore, some or all of the functionality described above with respect to authorization module 125, remediation module 192, or any of the functionality of the various nodes may be implemented as an application, such as any of applications 710.

The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that may include at least one hypervisor.

A hypervisor platform may be used to implement a hypervisor within the virtualization infrastructure 704, where the hypervisor platform has an associated virtual infrastructure management system. The underlying physical machines may include one or more distributed processing platforms that include one or more storage systems.

In other implementations of the FIG. 7 embodiment, the VMs/container sets 702 include respective containers implemented using virtualization infrastructure 704 that provides operating system level virtualization functionality, such as support for containers running on bare metal hosts, or containers running on VMs. The containers may be implemented using respective kernel control groups of the operating system.

One or more of the processing modules or other components of an information processing system may each run on a computer, server, storage device or other processing platform element. A given such element is viewed as an example of a computing device. The cloud infrastructure 700 shown in FIG. 7 may represent at least a portion of one processing platform. Another example of such a processing platform is processing platform 800 shown in FIG. 8.

The processing platform 800 in this embodiment may include a plurality of processing devices, denoted 802-1, 802-2, 802-3, . . . 802-K, which communicate with one another over a network 804. For instance, any of the devices of the users 104, 106, 108, 110, 115, 116, the devices of the owner 102, the endpoint node 112, and the control plane node 114, may be implemented as one or more processing devices 802.

The network 804 may include any type of network, including by way of example a global computer network such as the Internet, a WAN, a LAN, a satellite network, a telephone or cable network, a cellular network, a wireless network such as a Wi-Fi or 5G network, or various portions or combinations of these and other types of networks.

The processing device 802-1 in the processing platform 800 may include a processor 810 coupled to a memory 812. The processor 810 may include a microprocessor, a microcontroller, an application-specific integrated circuit (ASIC), a field-programmable gate array (FPGA) or other type of processing circuitry, as well as portions or combinations of such circuitry elements.

The memory 812 may include random access memory (RAM), read-only memory (ROM) or other types of memory, in any combination. The memory 812 and other memories disclosed herein should be viewed as illustrative examples of processor-readable storage media or computer-readable media storing executable program code (e.g., computer-readable instructions) of one or more software programs.

Articles of manufacture including such processor-readable storage media are considered illustrative embodiments. A given such article of manufacture may include, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products including processor-readable storage media can be used.

Also included in the processing device 802-1 is network interface circuitry 814, which is used to interface the processing device with the network 804 and other system components and may include conventional transceivers.

The other processing devices 802 of the processing platform 800 are assumed to be configured in a manner similar to that shown for processing device 802-1. Each of the processing devices 802 is an example of an information handling system (IHS). Information handling systems may include any of a variety of devices, such as servers, personal computers, smart phones, and the like. Any of the processing devices 802 may be configured to execute computer-readable instructions to perform actions associated with FIGS. 1-6.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the implementation(s) described herein embrace all such modifications and changes and, accordingly, the above description should be regarded in an illustrative rather than a restrictive sense.

Although the implementation(s) is/are described herein with reference to specific embodiments, various modifications and changes can be made without departing from the scope of the present implementation(s), as set forth in the claims below. Accordingly, the specification and figures are to be regarded in an illustrative rather than a restrictive sense, and all such modifications are intended to be included within the scope of the present implementation(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
performing a verification operation for a request for work, wherein the request for work includes a statement of work and a cryptographic chain of authorization, wherein the cryptographic chain of authorization includes a first authorization, which references a second authorization;
analyzing cached data of the chain of authorization, including the first authorization and the second authorization;
determining, based on the analyzing, that the first authorization has expired or been revoked;
transmitting a first message to a control plane node, the first message indicating a failure of the cryptographic chain of authorization;
receiving a second message from the control plane node, the second message including a substitute cryptographic chain of authorization;
verifying that the substitute cryptographic chain of authorization authorizes the request for work; and
performing work identified in the request for work.

2. The method of claim 1, wherein the substitute cryptographic chain of authorization replaces the first authorization with a third authorization and replaces the second authorization with a fourth authorization, wherein the substitute cryptographic chain of authorization includes a valid connection from a node having made the request for work to a root of authority.

3. The method of claim 1, wherein the request is made on behalf of a first node, and wherein the cryptographic chain of authorization includes a reference to a root authorization through the first authorization and the second authorization.

4. The method of claim 1, wherein the method is performed by an endpoint device in a multi-node environment, wherein the request for work is associated with an existing workload of the endpoint device.

5. The method of claim 1, wherein the first authorization includes a first cryptographic signature of a first node and a first delegation of authority to a second node, wherein the second authorization includes a second cryptographic signature of a third node and a second delegation of authority to the first node.

6. The method of claim 5, wherein the statement of work includes a signature of the second node.

7. The method of claim 5, wherein the substitute cryptographic chain of authorization includes a third delegation of authority to the second node from a fourth node that is different from the first node.

8. The method of claim 7, wherein the substitute cryptographic chain of authorization omits the first delegation of authority to the second node.

9. The method of claim 1, further comprising:
storing the request for work at an endpoint node and executing a workload corresponding to the statement of work;
restarting the endpoint node;
performing the verification operation on the request for work as stored at the endpoint node and in response to restarting the endpoint node.

10. The method of claim 9, wherein the workload is a long-standing workload.

11. An IHS (Information Handling System) comprising:
one or more processors;
one or more memory devices coupled to the one or more processors, the one or more memory devices storing computer-readable instructions that, upon execution by the one or more processors, cause the IHS to:
receive an indication of a request for work having a failed cryptographic chain of authorization, wherein the indication is received from an endpoint running a workload according to the request for work;
analyze cached cryptographic authorizations, including identifying a substitute cryptographic chain of authorization, sufficient to authorize the work, and connecting a node associated with the request for work to a root of authority; and
transmit a message, including the substitute cryptographic chain of authorization, to the endpoint.

12. The IHS of claim 11, wherein the computer-readable instructions cause the IHS to:
transmit a subsequent request for work, including a statement of work and the substitute cryptographic chain of authorization, in the message.

13. The IHS of claim 11, further comprising computer-readable instructions that cause the IHS to:
analyze the cached cryptographic authorizations by searching the cached cryptographic authorizations for a delegation of authority to a first node, which signed a statement of work of the request for work; and
substituting a first certificate of the failed cryptographic chain of authorization with a second certificate that includes the delegation of authority to the first node.

14. The IHS of claim 11, wherein the substitute cryptographic chain of authorization omits at least one certificate that is included in the failed cryptographic chain of authorization.

15. The IHS of claim 11, wherein the computer-readable instructions that cause the IHS to transmit the message include computer-readable instructions that cause the IHS to:
transmit within the message a statement of work, signed by a first node that first issued the request for work, further wherein the statement of work is a same statement of work included in the request for work.

16. The IHS of claim 15, wherein the statement of work indicates a long-standing work item.

17. The IHS of claim 11, wherein the computer-readable instructions that cause the IHS to analyze the cached cryptographic authorizations includes computer-readable instructions that cause the IHS to:
query a database of data associated with the cached cryptographic authorizations.

18. A computer-readable storage device having instructions stored thereon for decommissioning a cloud resource, wherein execution of the instructions by one or more processors of an information handling system (IHS) causes the one or more processors to:
perform a verification operation for a request for work, wherein the request for work includes a statement of work and a cryptographic chain of authorization, wherein the cryptographic chain of authorization includes a first authorization, which references a second authorization;
analyze cached data of the chain of authorization, including the first authorization and the second authorization;
determine, based on the analyzing, that the first authorization has expired or been revoked;
transmit a first message to a control plane node, the first message indicating a failure of the cryptographic chain of authorization;
receive a second message from the control plane node, the second message including a substitute cryptographic chain of authorization; and
perform work identified in the request for work based on verifying the substitute cryptographic chain of authorization.

19. The computer-readable storage device of claim 18, wherein the first authorization includes a first cryptographic signature of a first node and a first delegation of authority to a second node, wherein the second authorization includes a second cryptographic signature of a third node and a second delegation of authority to the first node.

20. The computer-readable storage device of claim 19, wherein the statement of work includes a signature of the second node.
